(19) United States
(12) Patent Application Publication
(10) Pub. No.: US 2007/0006020 A1
(43) Pub. Date: Jan. 4, 2007

(54) Inter-host data transfer method, program, and system

(75) Inventor: Kenichi Fujita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/229,700

(22) Filed: Sep. 20, 2005

(30) Foreign Application Priority Data
Jun. 30, 2005 (JP) 2005-191514

(51) Int. Cl. G06F 11/00

(52) U.S. Cl. 714/6

(57) ABSTRACT

RAID devices equipped with a remote copy function are respectively connected to a global server of a transfer source and an open server of a transfer destination, and the RAID devices are connected to each other by an inter-chassis path. Upon operation start-up, the global server of the transfer source issues a start instruction and session information of remote copy to the transfer-source RAID device, thereby establishing a session of remote copy in which a relay volume of the transfer-source RAID device is serving as a copy source and a relay volume of the transfer-destination RAID device is serving as a copy destination. When data transfer is instructed, the data specified by a data transfer instruction is read out from a global volume, converted by a data conversion unit, and written to a relay buffer area of the relay volume, thereby transferring it via the inter-chassis path through remote copy.

This application is a priority based on prior application No. JP 2005-191514, filed Jun. 30, 2005, in Japan.

### BACKGROUND OF THE INVENTION

1. Field of the Invention

The present invention relates to an inter-host data transfer method, a program, and a system for transferring data at high speed between hosts which are using different data formats and provided with volumes, and particularly relates to an inter-host data transfer method, a program, and a system for transferring data between the hosts at high speed by utilizing an inter-chassis path between RAID devices which are connected to the hosts.

2. Description of the Related Arts

Along with the recent development of networks, primarily, the internet, in addition to a global server serving as a mainframe, most suitable servers are disposed depending on the use, e.g., web processing is handled by a UNIX (R) server and e-mail processing is handled by an IA server, and, furthermore, a plurality of servers are gathered up at one location, thereby building up a data center. In such multi-server system environment, conventionally, data has been directly exchanged between the servers by use of a LAN; however, along with increase in data amount, the load on the LAN and CPUs of the servers increases in the data transfer using the LAN; and, in order to solve this, a high-speed data exchange program (for example, XL-Datamover of Fujitsu Ltd.) for realizing bidirectional high-speed file transfer between servers of different data formats by utilizing SAN-environment Fibre Channel has been used. The high-speed data exchange program is a solution for transferring data between one RAID device and two hosts connected thereto, wherein, since the RAID device connected to the hosts are utilized as a transmission path, LAN connection between the hosts is unnecessary, and high-speed data transfer that is not affected by LAN load can be performed.

FIG. 1 is an inter-host data transfer system using XL-Datamover 206 and 208 serving as conventional high-speed data exchange programs. A global server 200 and an open server 202 are connected to a RAID device 204 by Fibre Channel so as to share the RAID device, a relay buffer area is reserved in a volume of the RAID device 204, data of a file is written to the relay buffer area from the global server 200 of a transfer source by XL-Datamover 206, and, subsequently, the open server 202 reads out the data from the relay buffer area and creates a file. As a result, 1 GB data, which used to take two hours or more in a conventional LAN, can be transferred at high speed in about two minutes at the shortest time. On the other hand, in some system environment of multi-servers, data centers are separate in a plurality of locations, wherein a global server is disposed so as to be connected to a RAID device in a data center, and an open server is disposed so as to be connected to a RAID device in another data center; and high-speed data exchange for sharing data, even in such a case, between different types of servers is needed. As a method for performing data transfer between hosts which are connected to different RAID devices in the above described manner, any of the following methods has to be employed. In a first inter-host data transfer method, as shown in FIG. 2, the global server 200 and the open server 202 are individually connected to RAID devices 204 and 210, and data is transferred by a file transfer protocol (FTP) using a LAN 212 connecting them. In a second inter-host data transfer method, as shown in FIG. 3, transfer is carried out through three steps, wherein data to be transferred is placed in a volume 214 of the RAID device 204 from the global server 200, and the data is transferred to a volume 216 of the RAID device of the open server 202 by use of an inter-chassis path 218 by a remote copy function of the RAID device 204, and the transferred data is retrieved by the open server 202.

[Patent Document 1] Japanese Patent Application Laid-Open (kokai) No. 11-279678

However, the first inter-host data transfer method according to the file transfer protocol (FTP) using LAN which is mutually connecting the hosts connected to the different RAID devices involves a problem that load is imposed on the LAN, and load is also imposed on the host CPU due to transfer of the file transfer protocol (FTP). Also, the second inter-host data transfer method utilizing the remote copy function of the RAID device does not cause problems between the servers of the same OS; however, in data transfer between different types of servers, e.g., between a global server and an open server, although conversion of data code systems is apparently problematic, before anything, since the code formats of the global server and the open server are different, code format conversion by any of the servers is required before transfer, which causes a problem that CPU load of the server increases. In order to solve this problem, as shown in FIG. 1, it is conceivable to provide XL-Datamover in the servers; however, XL-Datamover performs data exchange between volumes on the assumption that volumes of two servers are allocated in one RAID device, and it cannot be applied to data transfer between volumes separately provided in the different RAID devices 204 and 210 as shown in FIG. 3.

### SUMMARY OF THE INVENTION

According to the present invention to provide an inter-host data transfer method, a program, and a system that enable high-speed data transfer involving data conversion between different types of hosts connected to different RAID devices.

The present invention provides an inter-host data transfer method. More specifically, the present invention is characterized by comprising an inter-host data transfer method in which RAID devices equipped with a remote copy function are respectively connected to a transfer-source host (global server) and a transfer-destination host (open server), and the RAID devices are connected to each other by an inter-chassis path, comprising,

in the transfer-source host (global server),

a remote copy instruction step of, upon operation start-up, issuing a start instruction and session information of remote copy to the transfer-source RAID device, and establishing a session of remote copy in which a particular area of a relay volume of the transfer-source RAID device is serving as a copy source and a particular area of a relay volume of the transfer-destination RAID device is serving as a copy destination, and a session of remote copy in which a particular area of the relay volume of the transfer-destination RAID device is serving as a copy source and a particular area of the relay volume of the transfer-source RAID device is serving as a copy destination, and

a transfer-source data exchange step of, when data transfer is instructed, reading out data, which is specified by a data transfer instruction, from a volume (global volume) for the host of the transfer-source RAID device, and writing the data to a relay buffer area of the relay volume, thereby subjecting the data to remote copy; and comprising,

in the transfer-destination host (open server),

a write monitoring step of monitoring write of transfer data through remote copy with respect to the relay volume of the transfer-destination RAID device, and

a transfer-destination data exchange step of, when transfer data write completion is detected in the write monitoring step, reading out the transfer data in a relay buffer area of the relay volume and storing the data to a volume (open volume) for the transfer-destination host. Herein, the transfer-source data exchange step is characterized by, preceding remote copy of the transfer data, writing data transfer instruction information to the relay volume of the transfer-source RAID device, thereby notifying it to the transfer-destination host via the transfer-destination RAID device through remote copy. In the transfer-source data exchange step, a code system of the transfer data read out from the volume for the transfer-source host is converted into a code system matched to the transfer-destination host, and the transfer data is written to the relay buffer area disposed in the relay volume of the transfer-source RAID device, thereby subjecting the data to remote copy; and, in the transfer-destination data exchange step, the transfer data written to the relay buffer area disposed in the relay volume of the transfer-destination RAID device through remote copy is read out and written to the volume for the transfer-destination host. As long as the volume for the transfer-source host is a RAID device (or a DISK device) connected to the transfer-source host, it is not necessarily the transfer-source RAID device; and the volume for the transfer-destination host is also not necessarily the transfer-destination RAID device as long as it is a RAID device (or a DISK device) connected to the transfer-destination host. In the remote copy instruction step, when a remote copy stop instruction is received, a stop command and session information are issued to the transfer-source RAID device, thereby releasing the sessions of remote copy. The transfer-source host and the transfer-destination host of the inter-host data transfer method of the present invention are a global server and an open server, a global server and a global server, or an open server and an open server. The present invention provides a program executed by a computer of the transfer-source host. More specifically, the present invention is characterized by causing a computer of a transfer-source host for accessing a transfer-source RAID device which is connected to, via an inter-chassis path, a transfer-destination RAID device connected to a transfer-destination host to execute

a remote copy instruction step of, upon operation start-up, issuing a start instruction and session information of remote copy to the transfer-source RAID device, and establishing a session of remote copy in which a particular area of a relay volume of the transfer-source RAID device is serving as a copy source and a particular area of a relay volume of the transfer-destination RAID device is serving as a copy destination, and a session of remote copy in which a particular area of the relay volume of the transfer-destination RAID device is serving as a copy source and a particular area of the relay volume of the transfer-source RAID device is serving as a copy destination; and

a transfer-source data exchange step of, when data transfer is instructed, reading out data, which is specified by a data transfer instruction, from a volume for the host of the transfer source, and writing the data to a relay buffer area of the relay volume, thereby subjecting the data to remote copy. In addition, the present invention provides a program executed by a computer of the transfer-destination host. More specifically, the present invention is characterized by causing a computer of a transfer-destination host for accessing a transfer-destination RAID device which is connected to, via an inter-chassis path, a transfer-source RAID device connected to a transfer-source host to execute

a write monitoring step of monitoring write of transfer data through remote copy with respect to the relay volume of the transfer-destination RAID device, and

a transfer-destination data exchange step of, when transfer data write completion is detected in the write monitoring step, reading out the transfer data in the relay volume and storing the data to a volume for the transfer-destination host. The present invention provides an inter-host data transfer system. More specifically, the present invention is characterized by comprising an inter-host data transfer system in which RAID devices equipped with a remote copy function are respectively connected to a transfer-source host and a transfer-destination host, and the RAID devices are connected to each other by an inter-chassis path, comprising,

in the transfer-source host (global server),

a remote copy instruction unit for, upon operation start-up, issuing a start instruction and session information of remote copy to the transfer-source RAID device, and establishing a session of remote copy in which a particular area of a relay volume of the transfer-source RAID device is serving as a copy source and a particular area of a relay volume of the transfer-destination RAID device is serving as a copy destination, and a session of remote copy in which a particular area of the relay volume of the transfer-destination RAID device is serving as a copy source and a particular area of the relay volume of the transfer-source RAID device is serving as a copy destination, and

a data exchange unit for, when data transfer is instructed, reading out data, which is specified by a data transfer instruction, from a volume for the transfer-source host, and writing the data to a relay buffer area of the relay volume 56, thereby subjecting the data to remote copy; and comprising,

in the transfer-destination host (open server),

a write monitoring unit for monitoring write of transfer data through remote copy with respect to the relay volume of the transfer-destination RAID device, and

a data exchange unit for, when transfer data write completion is detected by the write monitoring unit, reading out the transfer data in the relay volume and storing the data to a volume for the transfer-destination host. Note that details of the program and the inter-host data transfer system of the present invention are basically same as that of the inter-host data transfer method of the present invention.

According to the present invention, the RAID devices are directly connected to each other by the inter-chassis path; therefore, when data is exchanged by means of the remote copy function of the RAID devices between the hosts by utilizing the inter-chassis path, the data can be transferred at high speed without imposing load on the LAN which is mutually connecting the hosts and the CPUs of the hosts. Furthermore, by disposing relay volumes in the transfer-source RAID device and the transfer-destination RAID device in addition to dedicated volumes of the hosts and providing relay buffer areas therein, high-speed data exchange units (XL-Datamover) having a function of data exchange between two hosts of different types which are connected to the same RAID device can be operated in conjunction with remote copy between different types of hosts which are connected to individual RAID devices. More specifically, when transfer data is to be read out from the volume dedicated to the transfer-source host and written to the relay buffer, the high-speed data exchange unit (XL-Datamover) provided in the transfer-source host can convert the code system of the transfer data into a format matched to the transfer-destination host, thereby making the conversion process of the code format and the data format performed by the CPU of the host unnecessary, reducing the load on the CPU of the host, and performing high-speed data exchange. In addition, in parallel with write of converted transfer data with respect to the relay buffer area of the relay volume disposed in the RAID device of the transfer source, it is written to the transfer-destination relay volume (copy-destination volume) of the RAID device of the transfer destination by data transfer through remote copy; therefore, transfer write performed through transfer data read-out, data conversion, and remote copy can be processed at high speed.

The above and other objects, features, and advantages of the present invention will become more apparent from the following detailed description with reference to the drawings.

### BRIEF DESCRIPTION OF THE DRAWINGS

FIG. 1 is explanatory diagram of a conventional system in which, when a plurality of hosts are connected to one RAID device, high-speed data exchange is performed between the hosts by use of XL-Datamover;

FIG. 2 is explanatory diagram of a conventional system in which data transfer between hosts to which RAID devices are individually connected is performed by use of LAN;

FIG. 3 is explanatory diagram of a conventional system in which data transfer between hosts to which RAID devices are individually connected is performed by utilizing copy function of the RAID devices;

FIG. 4 is block diagram of a system configuration of the present invention;

FIG. 5 is block diagram of a hardware configuration of the RAID device of FIG. 4

FIG. 6 is block diagram of a functional configuration in the RAID device of FIG. 4;

FIG. 7 is block diagram of the hardware environment of a computer constituting the server of FIG. 4;

FIGS. 8A and 8B are block diagrams of a functional configuration of an inter-host data transfer process according to the present invention in which a global server serves as a transfer source;

FIGS. 9A and 9B are time charts of the inter-host data transfer process of FIGS. 8A and 8B;

FIGS. 10A and 10B are flow charts of a transfer-source host process in the global server of FIGS. 8A and 8B;

FIG. 11 is flow chart of a transfer-destination host process in the open server of FIGS. 8A and 8B;

FIG. 12 is flow chart of a transfer-source process in the RAID device of the transfer source of FIGS. 8A and 8B;

FIG. 13 is flow chart of a transfer-destination process in the RAID device of the transfer destination of FIGS. 8A and 8B;

FIG. 14 is explanatory diagram of a start command issued upon remote copy instruction of FIGS. 8A and 8B;

FIG. 15 is explanatory diagram of the session information transferred upon remote copy instruction of FIGS. 8A and 8B;

FIG. 16 is explanatory diagram of a stop command and session information issued upon remote copy instruction of FIGS. 8A and 8B;

FIG. 17 is explanatory diagram of the session information transferred along with issue of the stop command of FIGS. 8A and 8B and;

FIGS. 18A and 18B are block diagrams of functional configuration of an inter-host data transfer process according to the present invention in which an open server serves as a transfer source.

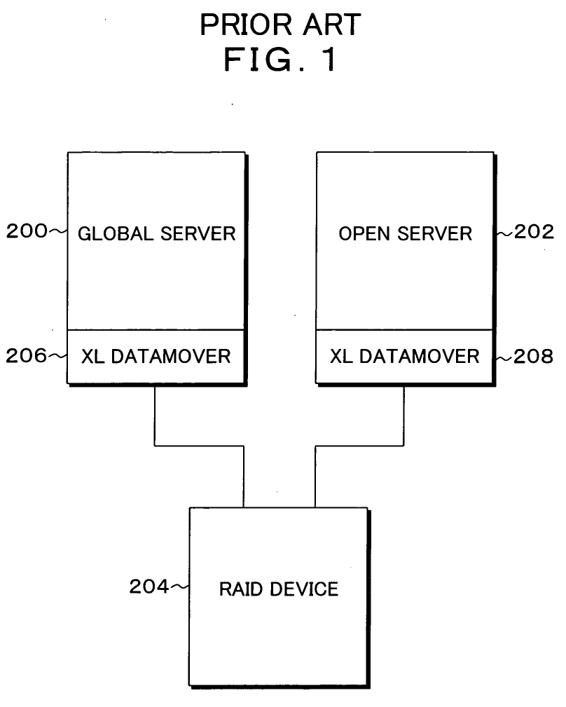

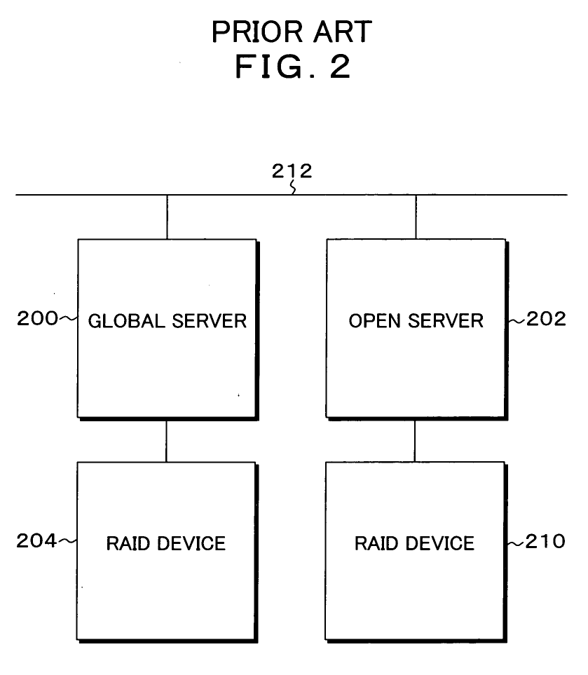

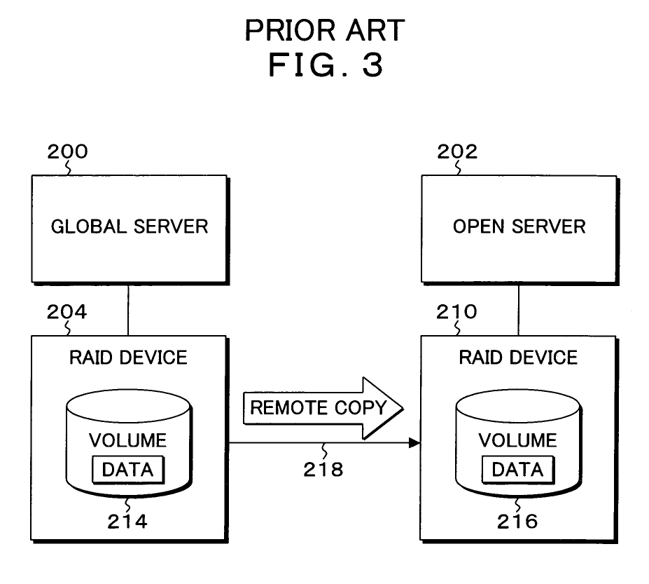

### DETAILED DESCRIPTION OF THE PREFERRED EMBODIMENTS

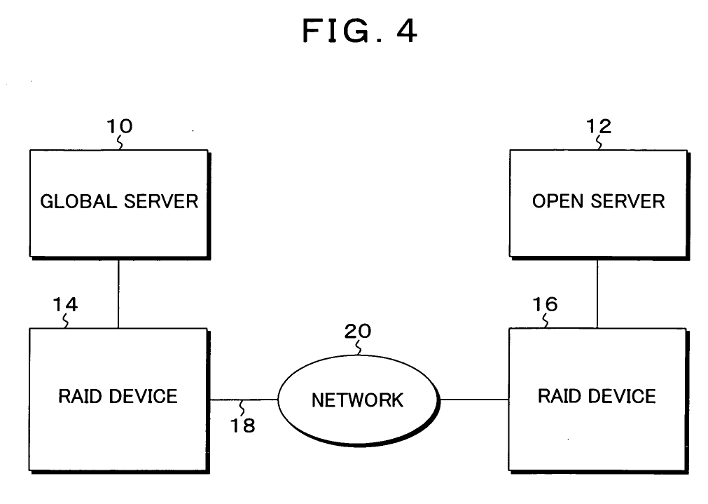

FIG. 4 is a block diagram of an inter-host data transfer system according to the present invention. In FIG. 4, in the inter-host data transfer system of the present invention, a global server 10 and an open server 12 are provided as hosts, a RAID device 14 is connected to the global server 10, and a RAID device 16 is connected to the open server 12. The RAID device 14 and the RAID device 16 are connected by an inter-chassis path 18, and, if they are greatly distant from each other, they are connected by the inter-chassis path 18 via a network 20. In the present invention, data exchange between the global server 10 and the open server 12 is performed by utilizing remote copy functions provided in the RAID devices 14 and 16, through the path using the inter-chassis path 18. As the global server 10 in FIG. 4, for example, a server of the GS21 series of Fujitsu Ltd. is used. On the other hand, as the open server 12, a Solaris server loaded with Solaris OS (Solaris OS) of Sun Microsystems Inc. is used. The present invention is not limited to the data exchange between the global server 10 and the open server 12, and the present invention can be also applied to data exchange mutually between global servers and mutually between open servers of different OSs by operating a high-speed data conversion function provided in each of the servers.

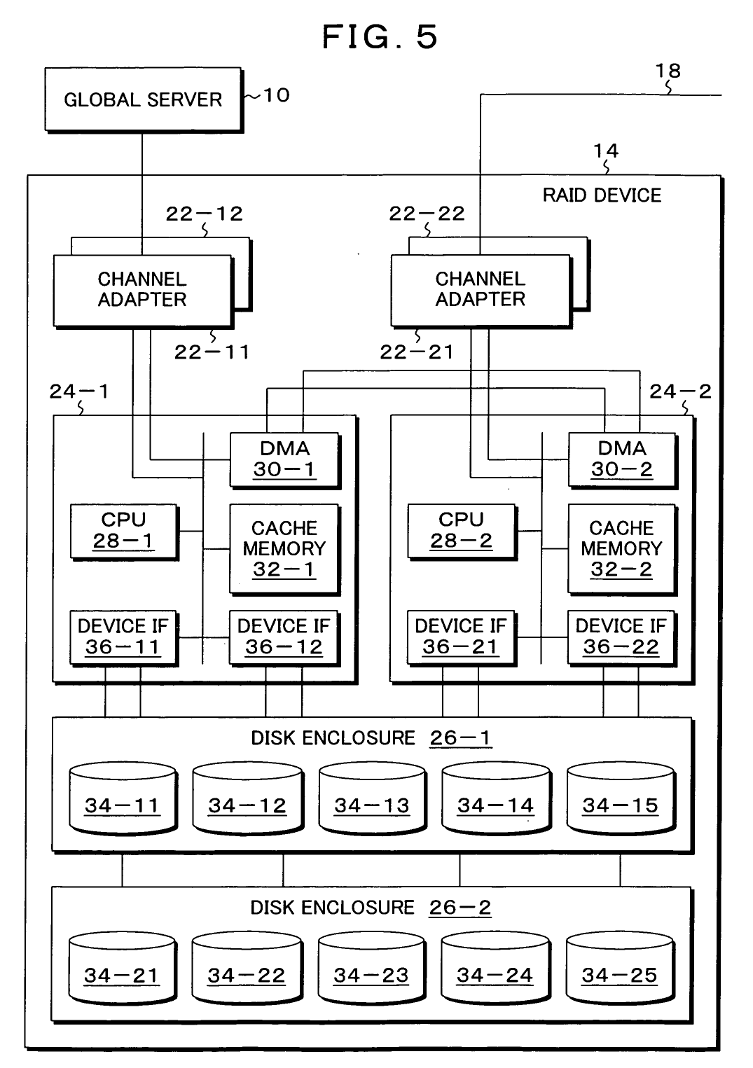

FIGS. 5A and 5B are block diagrams of a hardware configuration of the RAID device 14 of FIG. 4. Note that the RAID device 16 also has the same configuration. In FIGS. 5A and 5B, in the RAID device 14, channel adapters 22-11 and 22-12 and channel adapters 22-21 and 22-22 are provided in two separate systems, and the global server 10 is connected to the channel adapter 22-11. On the other hand, the other RAID device 16 shown in FIG. 4 is connected to the channel adapter 22-21 via the inter-chassis path 18. In addition, in the RAID device 14, in the present embodiment, duplexed control modules 24-1 and 24-2 are provided. Disk enclosures 26-1 and 26-2 are provided for the control modules 24-1 and 24-2, wherein five disk devices 34-11 to 34-15 and disk devices 34-21 to 34-25 employing magnetic disk devices are respectively provided. Each five disk devices 34-11 to 34-15 and 34-21 to 34-25 of the disk enclosures 26-1 and 26-2 constitute a disk array of a RAID configuration of a predetermined RAID level such as RAID Level 4 or RAID 5. In the control modules 24-1 and 24-2 provided are CPU 28-1 and 28-2, DMA controllers 30-1 and 30-2, cache memories 32-1 and 32-2, and device interfaces 36-11, 36-12, 36-21, and 36-22. Note that, as the RAID device 14 may comprise, other than the duplex configuration including the control modules 24-1 and 24-2, a multiplex configuration including a plurality of control modules, for example, eight of them.

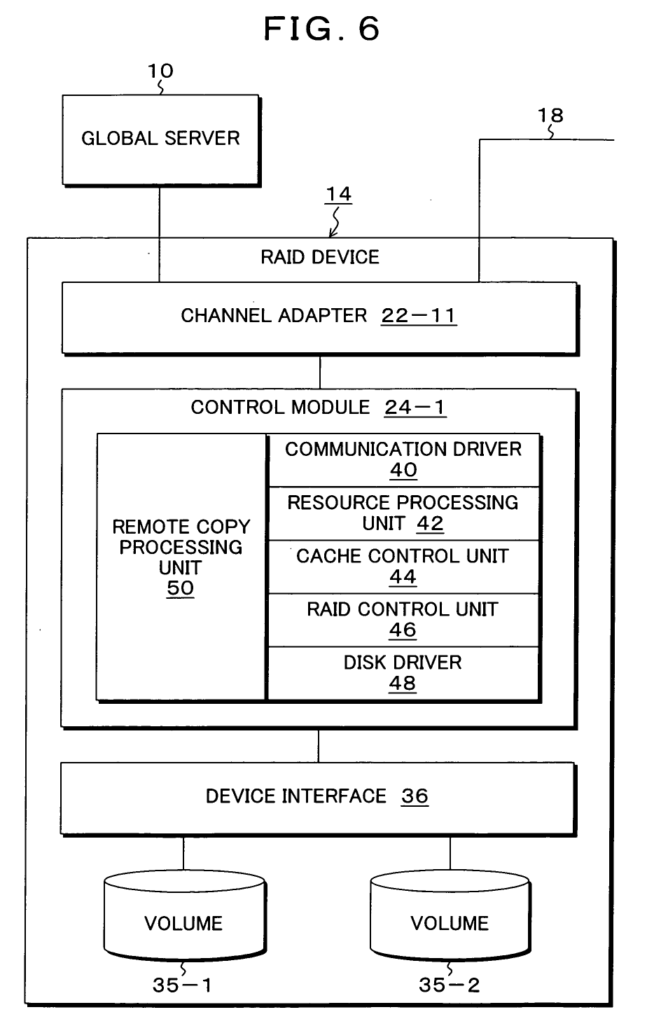

FIG. 6 is a block diagram of a functional configuration of the RAID device 14 of FIG. 4, and the RAID device 16 also has the same functional configuration. In FIG. 6, in the control module 24-1 which is provided subsequently to the channel adapter 22-11 of the RAID device 14 provided are, as functions realized by program control of the CPU 28-1 of FIGS. 5A and 5B, a communication driver 40, a resource processing unit 42, a cache control unit 44, a RAID control unit 46, a disk driver 48, and a remote copy processing unit 50. The communication driver 40 executes network processes between itself and the global server 10 via the channel adapter 22-11, and, at the same time, executes network processes for remote copy between itself and the other RAID device 16 via the channel adapter 22-21 and through the inter-chassis path 18. The resource processing unit 42, the cache control unit 44, the RAID control unit 46, and the disk driver 48 execute file processings with respect to a plurality of volumes 35-1 and 35-2 comprising the disk device groups of the disk enclosures 26-1 and 26-2 connected via a device interface 36. For example, when the global server 10 serves as a transfer source and the open server 12 connected thereto via the inter-chassis path 18 serves as a transfer destination, in response to a start command instructing start of remote copy and session information from the global server 10 upon occurrence of a data transfer request, the remote copy processing unit 50 establishes a plurality of sessions for remote copy between the RAID device 14 serving as a copy source and the RAID device 16 serving as a copy destination, and executes remote copy wherein a particular area of the RAID device 14 serves as a copy source and a particular area of the RAID device 16 serves as a copy destination, and a particular area of the RAID device 16 serves as a copy source and a particular area of the RAID device 14 serves as a copy destination. A basic process of remote copy in the present invention will be explained as the following. Remote copy in the present invention is remote equivalent copy (Remote Equivalent Copy), and is a function for copying entire or partial data of a copy source volume of the RAID device 14 which is specified as a copy source to the same track position (CCHH) of a copy destination volume of the RAID 14 which is specified as a copy destination by data transfer via the inter-chassis path 18. In this remote copy, after sessions of the remote copy are established between the RAID device 14 of the copy source and the RAID device 16 of the copy destination via the inter-chassis path 18, when data is written to the copy-source volume, data transfer to the copy destination volume is automatically started, and it is operated in a duplex state in which the same data is written to the copy-source volume and the copy-destination volume. This is called a duplex pair. The inter-host data transfer of the present invention utilizes equivalency function that remote copy has. That is, when transfer data is written to a relay volume of the transfer source, it is reflected to a relay volume of the transfer destination by the equivalency function of remote copy. Once-established sessions of remote copy can be released by a stop command from the global server 10.

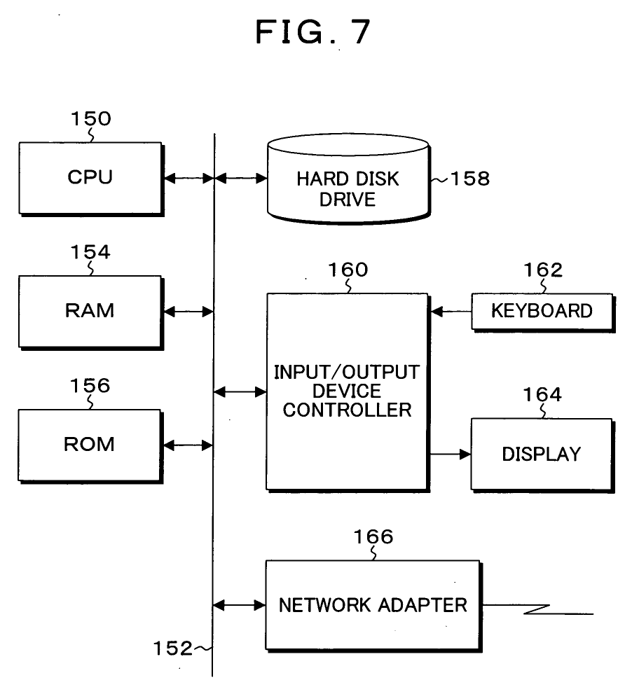

FIG. 7 is a block diagram of a hardware environment of the computer constituting the global server 10 of FIG. 4, and the open server 12 side also has the same configuration. In FIG. 7, a RAM 154, a ROM 156, a hard disk drive 158, an input/output device controller 160 to which a keyboard 162 and a display 164 are connected, and a network adapter 166 for connecting a network for a channel path are connected to a bus 152 of a CPU 150. The hard disk drive 158 is loaded with a processing program for executing, for example, core tasks of the global server 10, a remote copy control program for realizing inter-host data transfer of the present invention, and a data exchange program for performing data exchange between different types of servers; and, upon startup of the computer, the programs are read out from the hard disk drive 158, deployed in the RAM 154, and executed by the CPU 150.

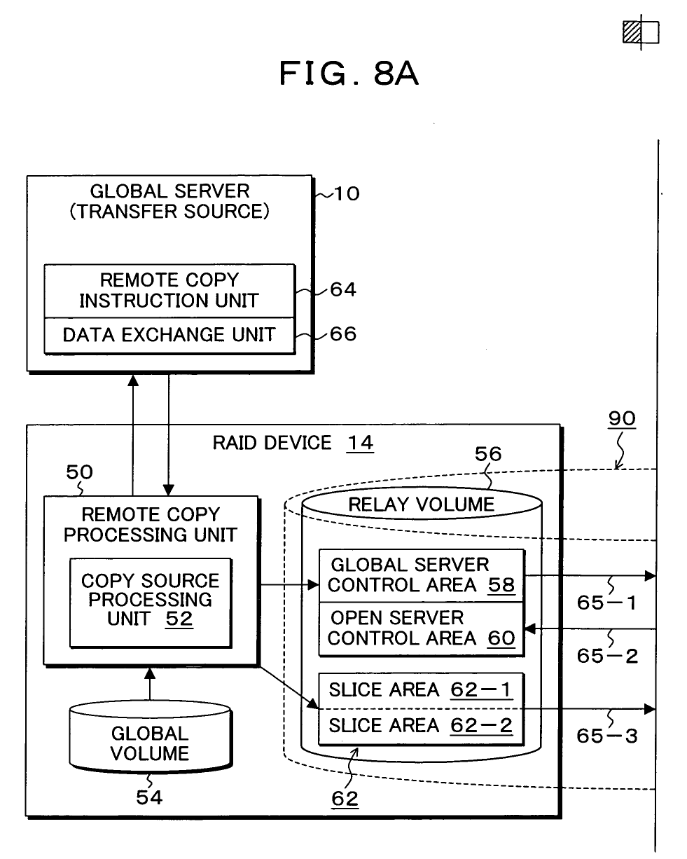

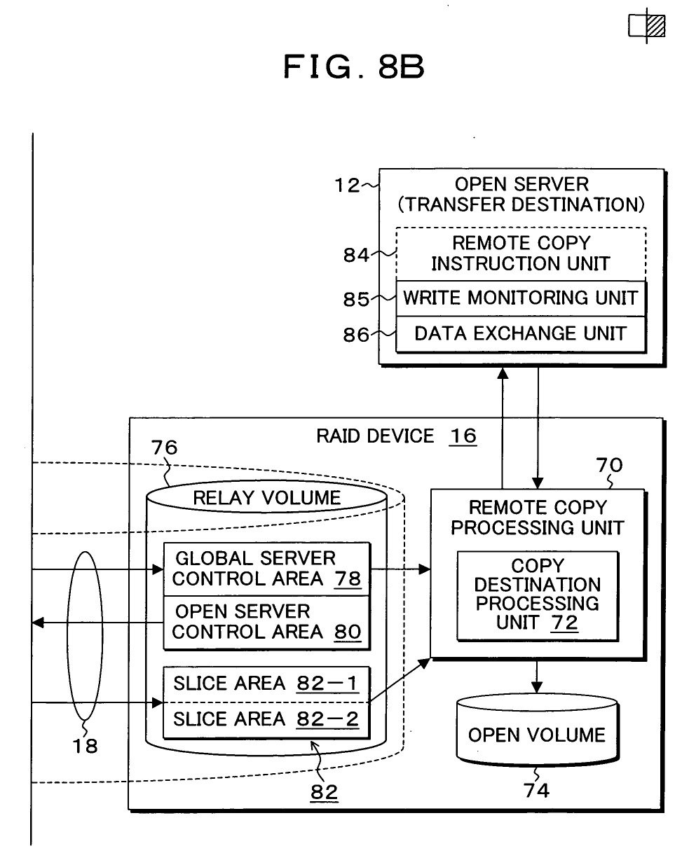

FIGS. 8A and 8B are block diagrams of a functional configuration of an inter-host data transfer process according to the present invention wherein the global server 10 serves as a transfer source and the open server 12 serves as a transfer destination. In FIGS. 8A and 8B, the remote copy processing unit 50 is provided in the RAID device 14 which is connected to the global server 10, and a function serving as a copy source processing unit 52 is provided in the remote copy processing unit 50. In addition, in the RAID device 14, a global volume 54 can be provided as a volume on which input and output of the global server 10 is to be performed. The global volume may be a volume that is in another RAID device or a DISK device connected to the global server 10. Furthermore, in the RAID device 14, a relay volume 56 constituting the copy source volume of remote copy is provided. A global server control area 58, an open server control area 60, and a relay buffer area 62 are allocated to the relay volume 56. In addition, functions of a remote copy instruction unit 64 and a data exchange unit 66 are provided in the global server 10. On the other hand, a remote copy processing unit 70 is similarly provided in the RAID device 16 connected to the open server 12 of the copy destination, wherein a function serving as a copy destination processing unit 72 is activated since the remote copy processing unit 70 is the copy destination. In addition, an open volume 74 to be subjected to input/output processes of the open server 12 can be provided in the RAID device 16. The open volume may be a volume in another RAID device or a DISK device connected to the open server. Furthermore, in the RAID device 16, a relay volume 76 which is used as a copy destination volume upon remote copy is provided, and a global server control area 78, an open server control area 80, and a relay buffer area 82 are allocated to the relay volume 76. In the state in which sessions 65-1, 65-2, and 65-3 which are necessary for remote copy are established between the RAID device 14 and the RAID device 16, the relay volume 56 of the copy source and the relay volume 76 of the copy destination constitute a duplex pair via the inter-chassis path 18, and equivalent can be ensured for the storage data in the global server control areas 58 and 78, the open server control areas 60 and 80, and the relay buffer areas 62 and 82 such that the same data is attained therein through remote copy. In the open server 12 serving as the transfer destination, functions of a remote copy instruction unit 84, a write monitoring unit 85, and a data exchange unit 86 are provided. Note that, although the write monitoring unit 85 is a function included in the data exchange unit 86, it is illustrated outside thereof. For example, when a data transfer request is generated according to an instruction from a user for transferring data as a batch process, the remote copy instruction unit 64 provided in the global server 10 serving as the transfer source issues a start command serving as a start instruction of remote copy and session information to the RAID device 14 of the transfer source; and, by use of the function of the copy source processing unit 52 of the remote copy processing unit 50, establishes the two sessions 65-1 and 65-3 for the remote copy in which the relay volume 56 of the RAID device 14 serves as a copy source and the relay volume 76 of the RAID device 16 of the transfer destination serves as a copy destination, and establishes the session 65-2 for the remote copy in which the relay volume 76 of the RAID device 14 serves as a copy source and the relay volume 56 of the RAID device 14 serves as a copy destination. In the state in which the sessions 65-1 to 65-3 of remote copy are established, the data exchange unit 66 provided in the global server 10 writes data transfer instruction information to the global server control area 58 of the relay volume 56 and transfers it through remote copy.

Herein, the data transfer instruction information generated by the data exchange unit 66 comprises:

(1) transfer source data set name,

(2) volume serial number of the relay volume 56,

(3) transfer direction,

(4) server name of the open server 12, and

(5) transfer destination file name.

The data set of global servers is the idea corresponding to a file of open servers.

When a reception response from the transfer destination is obtained with respect to the remote copy of the data transfer instruction information via the relay volume 56, the data exchange unit 66 reads out the data of the specified data set from the global volume 54, writes it to the relay buffer area 62 of the relay volume 56, thereby transferring it through remote copy. Herein, the relay buffer area 62 is divided into slice areas 62-1 and 62-2, and, when data write to the slice area 62-1 is completed, it is switched to data write of the slice area 62-2. At the same time, the data in the slice 62-1, to which data has been written, is sequentially read out from the slice area 62-1 and transferred through remote copy. In the data write from the global server 10 and the data transfer through remote copy, the data transfer is not performed after data write to the slice area 62-1 is completed, but the data is transferred asynchronously while ensuring the sequence in order to improve the transfer performance. Thereafter, this is cyclically repeated. Therefore, even when the data set exceeds the capacity of the relay buffer area 62, it can be transferred through remote copy without being restricted by the capacity of the relay buffer area 62. Furthermore, in the data transfer using remote copy by the data exchange unit 66, every time a data transfer request is generated, a set of another global server control area, another open server control area, and another relay buffer area is allocated to an unused area in each of the relay volume 56 of the relay source and the relay volume 76 of the relay destination, three sessions are established between them, and data transfer utilizing remote copy is performed through the multiplex processing. The multiplexing number of the data exchange utilizing the remote copy can be realized within the range of the maximum number of the sessions that can be set up between the RAID devices 14 and 16. Herein, the global server 10 serves as the transfer source and the open server 12 serves as the transfer destination; however, inversely, data may be transferred from the open server 12 to the global server 10 in the data exchange, and, in this case, the inverse relation in which the open server 12 serves as the transfer source and the global server 10 serves as the transfer destination is established. The data exchange unit 66 provided in the global server 10 is capable of converting code systems if necessary. For example, it converts the EBCDIC code system of the global server 10 to the EUC code system of the open server 12. Specifically, XL-Datamover of Fujitsu Ltd. is used as the data exchange unit 66. XL-Datamover performs data exchange between, for example, a global server of GS 21 series of Fujitsu Ltd. and a Solaris server loaded with a Solaris OS of Sun Microsystems Inc. In addition, as data exchange between open servers, data exchange between a Solaris OS server and another UNIX (R) server, an IA server, or a Linux server can be performed.

When data exchange is performed while the global server 10 serves as the transfer source and the open server 12 serves as the transfer destination as shown in FIGS. 8A and 8B, the data exchange unit 66 provided in the global server 10 leads the data exchange, and, in this case, data transfer is performed as a batch job with respect to the data exchange unit 66. Herein, the data exchange unit 86 provided in the open server 12 of the transfer destination subordinately functions as a daemon process. Meanwhile, in data exchange between open servers of a Solaris OS server and another UNIX (R) server, or a Solaris OS server and an IA server, data exchange is executed when a command is issued to the data exchange unit 66 provided in the open server of the transfer source.

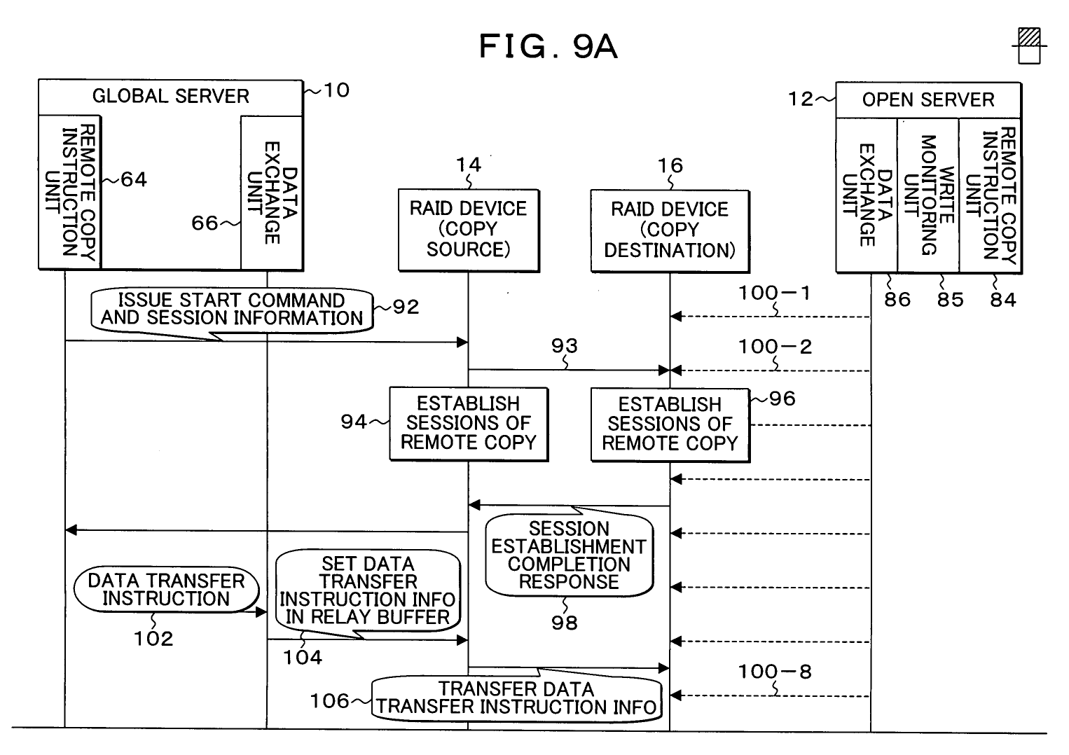

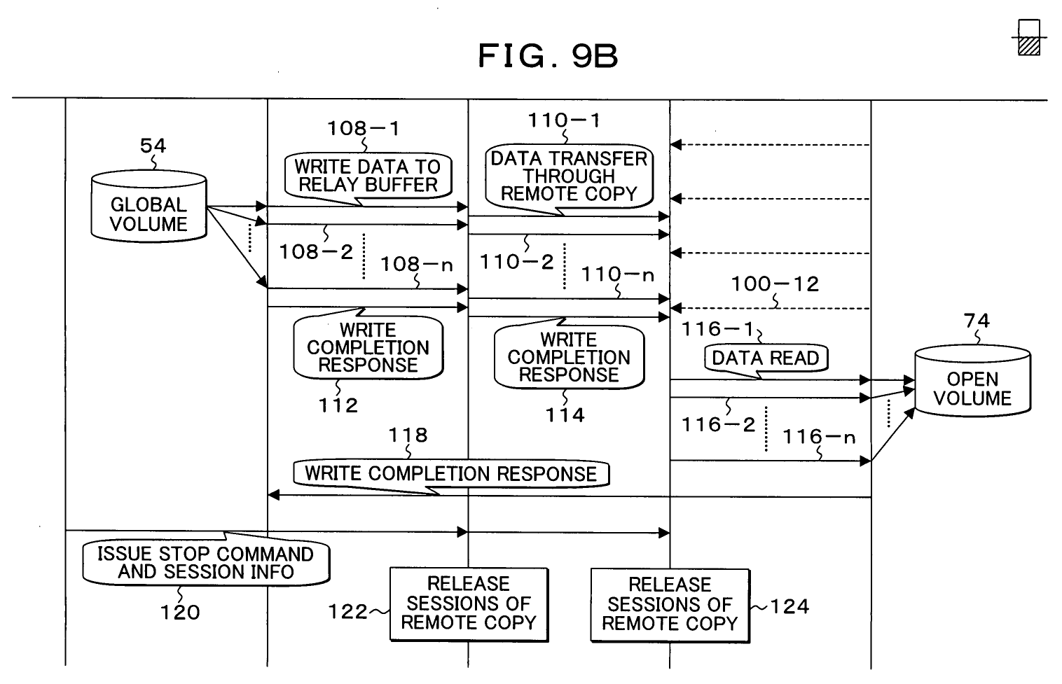

FIGS. 9A and 9B are time charts of the inter-host data transfer process in FIGS. 8A and 8B. In FIGS. 9A and 9B, when a data transfer request is generated by a batch process, etc. in the global server 10, in a process 92, the remote copy instruction unit 64 of the global server 10 issues a start command and session information of remote copy to the RAID device 14 via the data exchange unit 66. The start command and the session information of remote copy are further transferred to the RAID device 16 of the transfer destination via the inter-chassis path 18. In response to this, the RAID device 14 allocates, to the relay volume 56 of itself, the global server control area 58 and the relay buffer area 62 as copy sources and the open server control area 60 as a copy destination as shown in FIGS. 8A and 8B. Also, the RAID device 16 serving as the counterpart allocates, to the relay volume 76, the global server control area 78 and the relay buffer area 82 as copy destinations and the open server control area 80 as a copy source. Then, the RAID devices 14 and 16 establish the sessions 65-1, 65-2, and 65-3 for remote copy. After the sessions 65-1 to 65-3 of remote copy are established in this manner between the RAID device 14 and the RAID device 16, the remote copy for data exchange between the RAID device 14 and the RAID device 16 via the inter-chassis path 18 can be performed.

Subsequently, the data exchange unit 66 issues data transfer instruction information as shown in a process 104, the converted data transfer instruction information is written to the global server control area 58 of the relay volume 56 provided in the RAID device 14 of the copy source, and, when the write is completed, the data transfer instruction information is transferred and written to the RAID device 16 by the remote copy function as shown in a process 106. Meanwhile, the write monitoring unit 85 of the open server 12 of the transfer destination performs polling 100-1 to 100-12 for detecting data transfer instructions with respect to the global server control area 78 at a predetermined time interval. Therefore, at the polling 100-2, write of the data transfer instruction information with respect to the global server control area 78 is recognized.

Subsequently, the data exchange unit 66 of the global server 10 starts a data transfer process of the specified data set. More specifically, read of the specified data set in the global volume 54 is started from the top address thereof, and it is written to one of the slice areas, 62-1, of the relay buffer area 62 allocated to the relay volume 56 of the RAID device 12 as shown in processes 108-1 to 108-n. In conjunction with the write to the slice area 62-1, data transfer 110-1 to 110-n through remote copy is performed, and write to the slice area 82-1 of the relay buffer 82 of the RAID device 16 is performed. Herein, if write of all data of the data set to the slice area 62-1 is completed in the process 108-n, the data exchange unit 66 writes a write completion notification 112, in which a write completion flag is on, to the global server control area 58 of the relay volume 56. The write completion notification 114 in the global server control area 58 is written to the global server control area 78 of the RAID device 16 through remote copy. When the write monitoring unit 85 of the transfer destination recognizes the write completion notification in he global server control area 78 at the polling 100-12, as shown in processes 116-1 to 116-n, the data exchange unit 86 reads out data from the slice area 82-1, and writes it to the open volume 74. The data conversion unit 86 recognizes the transfer data length according to the data transfer instruction information, and when the data amount written to the open volume 74 matches the transfer data length, it recognizes data transfer completion, writes a write completion response 118 to the open server control area 80, and reflects it to the open server control area 60 through remote copy, thereby causing the data exchange unit 66 of the global server 10 to recognize it. As a result, a series of data transfer processes from the global server 10 to the open server 12 according to a data transfer instruction 102 is completed. The remote copy instruction unit 64 which has received a notification of data transfer process completion from the data exchange unit 66 issues a stop command and the session information of the target to be stopped to the RAID device 14 as shown in a process 120, and further issues that to the RAID device 16 via the RAID device 14. As a result, remote-copy session release 122 and 124 is carried out at the RAID devices 14 and 16, and a series of the data transfer processes is completed.

Herein, FIGS. 9A and 9B employs, as an example, a case in which the size of the data set is equal to or smaller than the size of the slice area 62-1; however, if it exceeds the slice area 62-1, when data write to the slice area 62-1 is completed, a write completion notification is written to the global server area 58, and it is reflected to the global server control area 78 of the copy destination through remote copy, so as to perform data write to the next slice area 62-2 and write data to the slice area 82-2 through remote copy. When write to the slice area 62-2 is completed, in the same manner as the preceding process, a completion notification of write to the slice area 62-2 is written to the global server control area 58, thereby reflecting it to the global server control area 78 of the copy destination through remote copy. In other words, in the copy source, the slice areas 62-1 and 62-2 are cyclically switched and write is performed thereon, and it is reflected to the slice areas 82-1 and 82-2 by performing data transfer through remote copy. Also, in the copy destination, the slice areas 82-1 and 82-2 are cyclically switched while referencing a write completion notification, and, at the same time, the transfer data is read out and written to the open volume 74. In this case, when read completion notifications of the slice areas 82-1 and 82-2 in the copy destination are written to the open server area 80, they are reflected to the open server area 60 of the copy source through remote copy; therefore, when write to the slice area 62-2 is completed, it is switched to write to the slice area 62-1 when a read completion notification of the slice area 82-1 of the copy destination comes. Note that FIGS. 9A and 9B illustrates one data transfer request generated in the global server 10 as an example, and, in practice, a plurality of data transfer requests is generated in a multiplex manner and the processes of FIGS. 9A and 9B are executed in parallel.

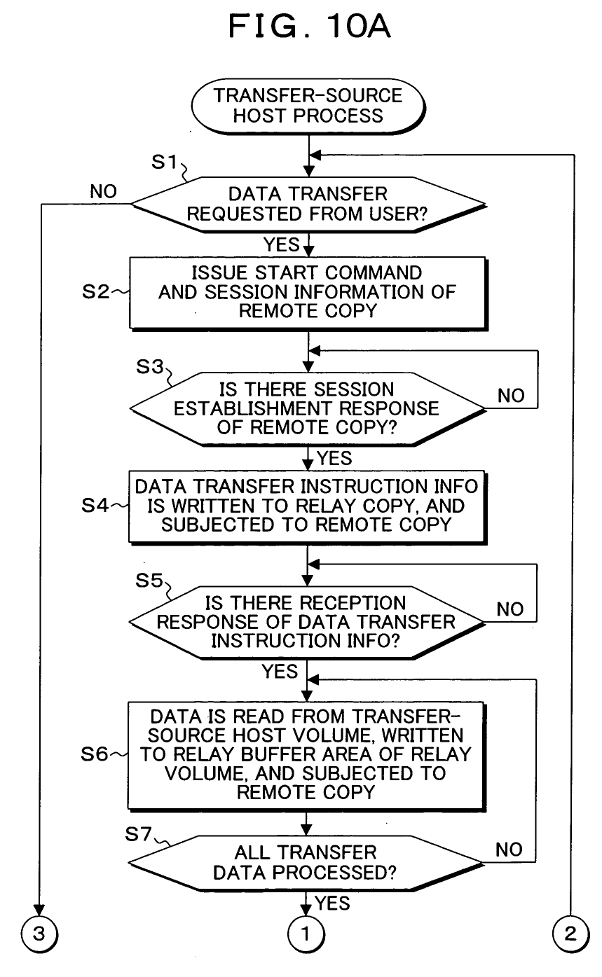

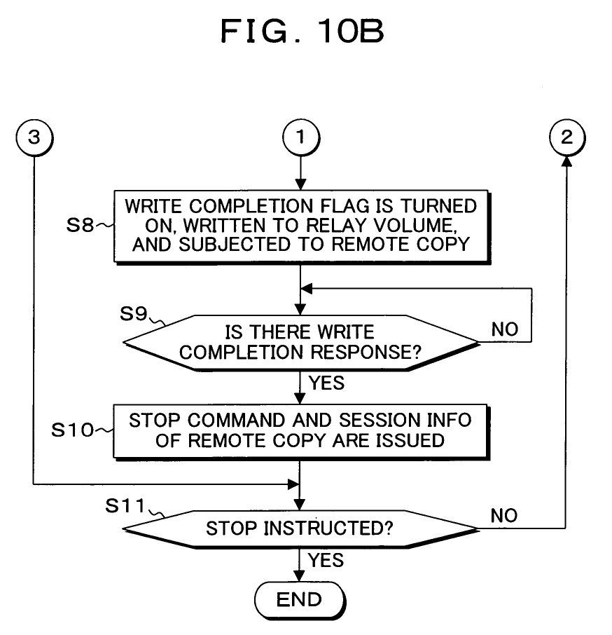

FIGS. 10A and 10B are flow charts of a transfer-source host process in the global server 10 of FIGS. 8A and 8B. In FIGS. 10A and 10B, in the transfer-source host process, presence of a data transfer instruction from a user is checked in step S1, if there is a data transfer instruction, a start command and session information of remote copy are issued to the RAID device 14 of its own in step S2, and an establishment response of session information of remote copy is awaited in step S3, and the process proceeds to step S4 if there is an establishment response. In step S4, data transfer instruction information is written to the global server control area 58 in the relay volume 56 of the RAID device 14, thereby causing it to be written to the global server control area 78 of the relay volume 76 of the RAID device 16 of the transfer destination through remote copy. Subsequently, presence of a reception response of the data transfer instruction information from the transfer destination is checked in step S5, and, if a reception response is determined, in step S6, the data of the specified data set is read out from the global volume 54, which is a volume for the transfer-source host, is written to the relay buffer area 62 of the relay volume 56, and is written to the relay buffer area 82 of the relay volume 76 of the RAID device 16 of the transfer destination through remote copy. Next, whether all transfer data has been processed or not is checked in step S7, and, if it is unprocessed, the process returns to step S6 in which a similar process is repeated. When it is determined that all transfer data has been processed, in step S8, a write completion flag is turned on and written to the global server control area 58 in the relay volume 56 of the RAID device 14, as a result, it is written to the global server control area 78 in the relay volume 76 of the RAID device 16 of the transfer destination through remote copy, thereby notifying it to the transfer side. In this state, when a write completion response from the transfer destination is determined in step S9, the process proceeds to step S10, and a stop command and the session information of the sessions which are to be stopped are issued to the RAID device 14, thereby releasing the active sessions of remote copy. Then, until stop is instructed in step S11, the process returns to step S1 wherein a next data transfer request is awaited.

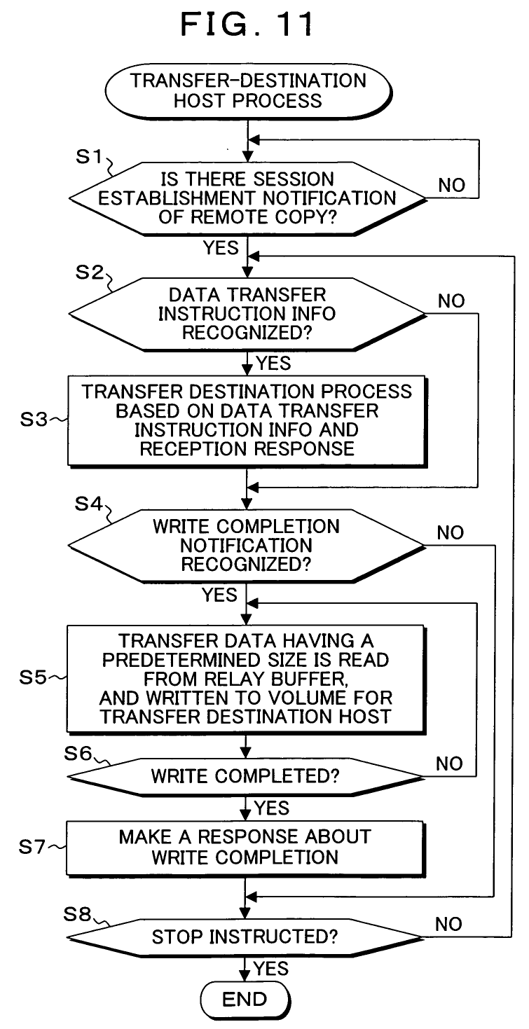

FIG. 11 is a flow chart of a transfer-destination host process in the open server of FIGS. 8A and 8B which ise serving as the transfer destination. In FIG. 11, the open server 12 checks a session establishment notification of remote copy in step S1, and when sessions are established, the process proceeds to step S2 wherein data transfer instruction information is recognized through polling which is performed with respect to the relay volume 76 of its own at a predetermined time interval, and then, a transfer-destination process based on the data transfer instruction information and reception response are performed in step S3. When a write completion notification is recognized in step S4 through polling with respect to the relay volume 76 in step S4, in step S5, the transfer data having a predetermined size is read out from the relay buffer area 82 and written to the open volume 74 which is serving as a volume for the transfer-destination host. In step S6, whether write of all data has been completed or not is checked with respect to the write of the transfer data from the relay buffer area 82 to the open volume 74, and, when write completion of the transfer data length that has been recognized from the data transfer instruction information is determined, a write completion response is made with respect to the transfer source in step S7. Such steps S2 to S7 are repeated until stop is instructed in step S8.

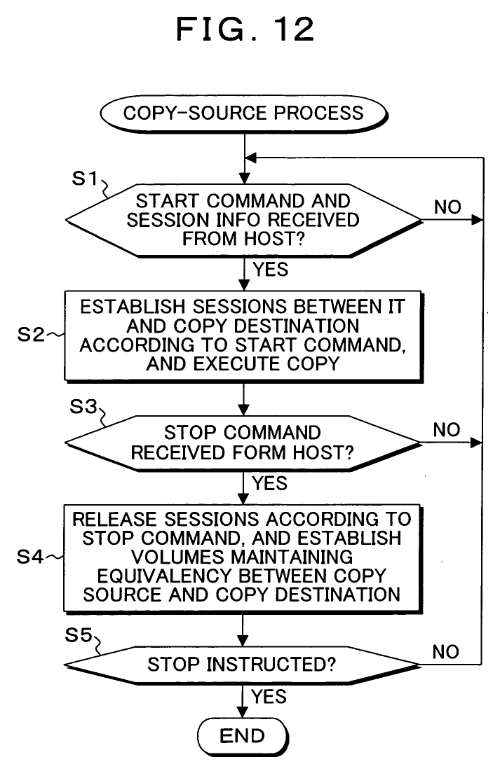

FIG. 12 is a flow chart of a copy-source process in the RAID device 14 of the transfer source of FIGS. 8A and 8B. In FIG. 12, in the copy-source process, after a start command and session information from the global server 10, which is serving as a host, are received, in step S2, sessions are established between it and the copy destination according to the start command, thereby executing remote copy. When a stop command is received from the side of the global server 10 which is serving as a host in step S3; the sessions are released according to the stop command, and volumes maintaining equivalency are established in the copy source and the copy destination in step S4. The process of steps S1 to S4 is repeated until stop is instructed in step S5.

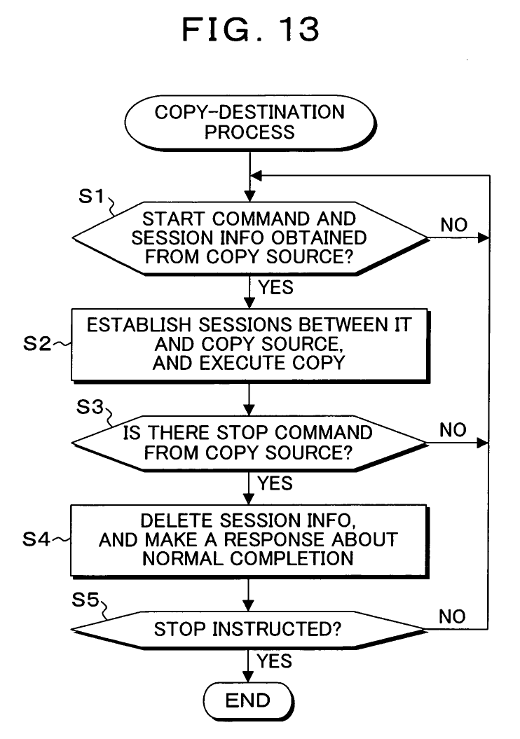

FIG. 13 is a flow chart of a copy-destination process in the RAID device 16 of the copy destination of FIGS. 8A and 8B. In FIG. 13, in the copy-destination process, a start command and session information from the copy source are monitored in step S1, and, when they are obtained, sessions are established between it and the copy source, thereby executing copy in step S2. Whether there is a stop command from the copy source or not is checked in step S3; and, when a stop command is received, the session information is deleted and a response about normal completion is made in step S4. The process of steps S1 to S4 is repeated until stop is instructed in step S5.

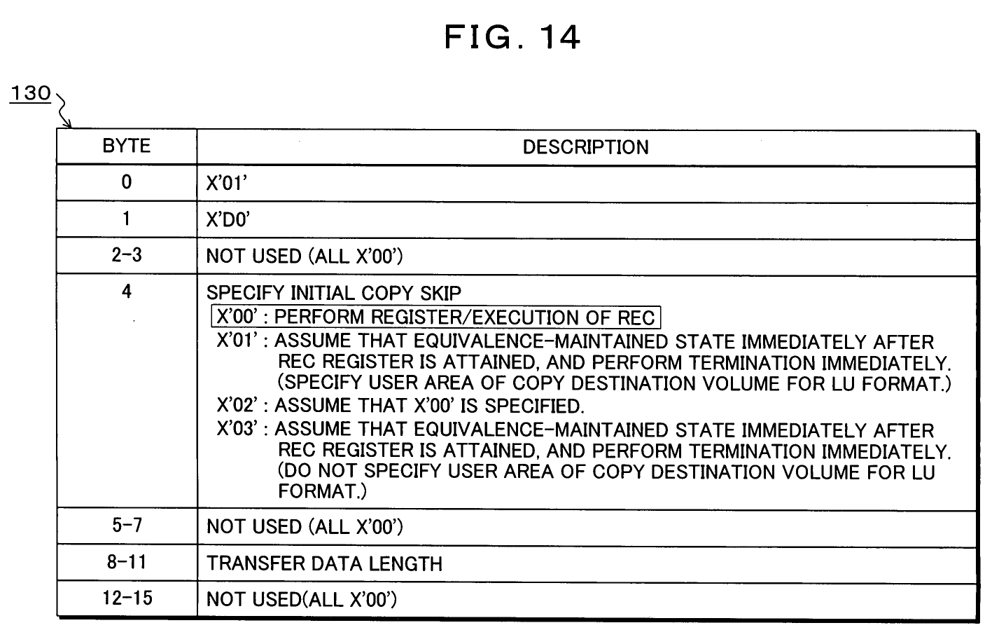

FIG. 14 is an explanatory diagram of a start command 130 provided by a command interface of the remote copy instruction unit 64 which is provided in the global server 10 of FIGS. 8A and 8B. The start command 130 is for performing register and execution for starting remote copy, and has the following functions.

(1) Recognize and set the copy source volume and the copy destination volume as a duplex pair (setting of a duplex pair).

(2) After setting of the duplex pair, copy the data which is in an area specified by the host from the copy source volume to the copy destination volume (execution of copy).

(3) Synchronize the copy source volume with the copy destination volume even after copy is completed (maintenance of equivalency). The start command 130 for starting such remote copy consists of Bytes 0 to 15, wherein Bytes 0 to 1 comprise a command code “X′01D0′” which indicates that it is a start command. Byte 0 is specification of initial copy skip, and in remote copy, when “X′00′” is specified as initial copy skip specification, register/execution of remote copy can be performed.

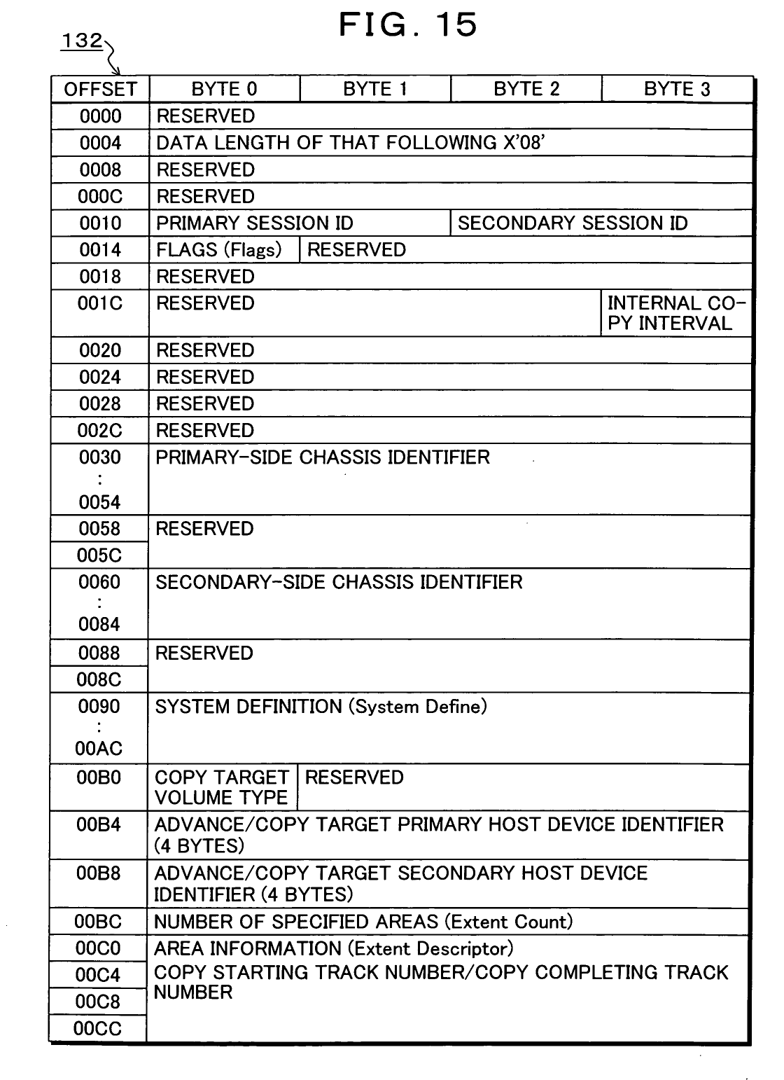

FIG. 15 is an explanatory diagram of session information 132 transferred by the start command 130 of FIG. 14. The session information 132 mainly comprises:

(1) data length of that following X′08′,

(2) primary session ID and secondary session ID,

(3) flag which determines remote copy when set to “1”,

(4) internal copy interval specifying the copy process interval,

(5) primary-side chassis identifier,

(6) secondary-side chassis identifier,

(7) system definition for setting arbitrary information for applications of the host,

(8) copy target volume type specifying the type of the copy target volume,

(9) copy target primary host device identifier,

(10) copy target secondary host device identifier,

(11) number of specified areas, wherein “0” specifies all volume areas as the copy target and “1” or more specifies the number of area(s), and

(12) area information according to copy starting track number/copy completing track number. Note that the area information is present in an amount corresponding to the number of specified areas.

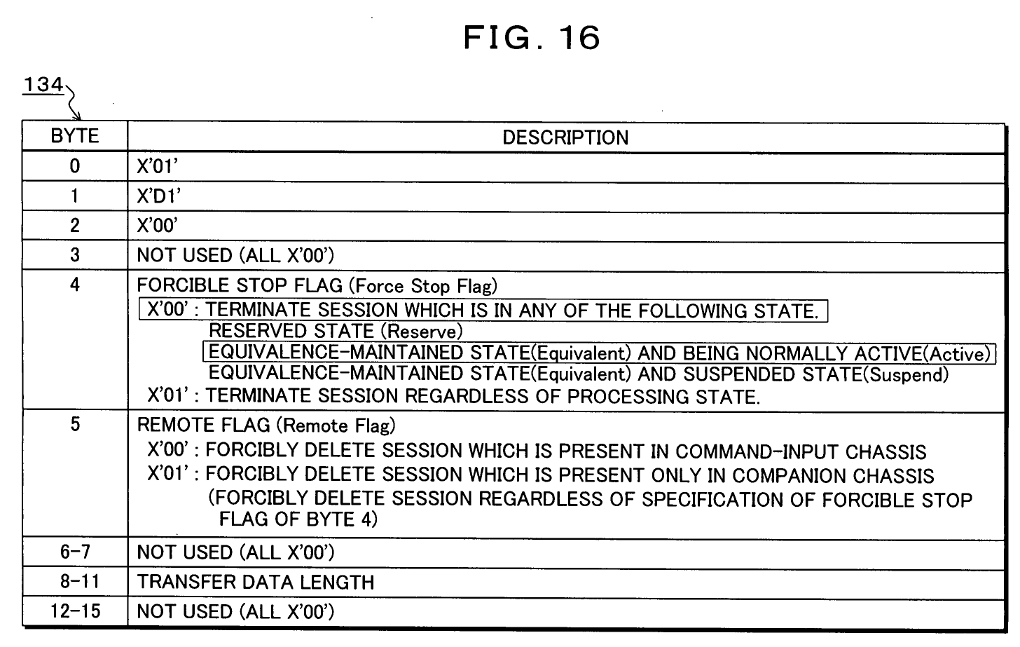

FIG. 16 is an explanatory diagram of a stop command 134 used in the present invention. The stop command 134 terminates a remote copy process with respect to a copy source volume and a copy destination volume. This copy termination process performs the following processes.

(1) The information relating sessions are released, and the association relation of the duplex pair is dissolved (dissolution of duplex pair).

(2) When duplex pair dissolution is instructed during a copy process, an error is returned to the instruction, and the pair-set state is maintained without terminating the copy process. However, if a forcible termination parameter (forcible stop flag=X′01′) is specified in the stop command for dissolving the pair, the pair is forcibly dissolved and the process is terminated (copy termination).

(3) After copy is terminated, the pair relation of the copy source volume and the copy destination volume is discarded, and the session information is also deleted.

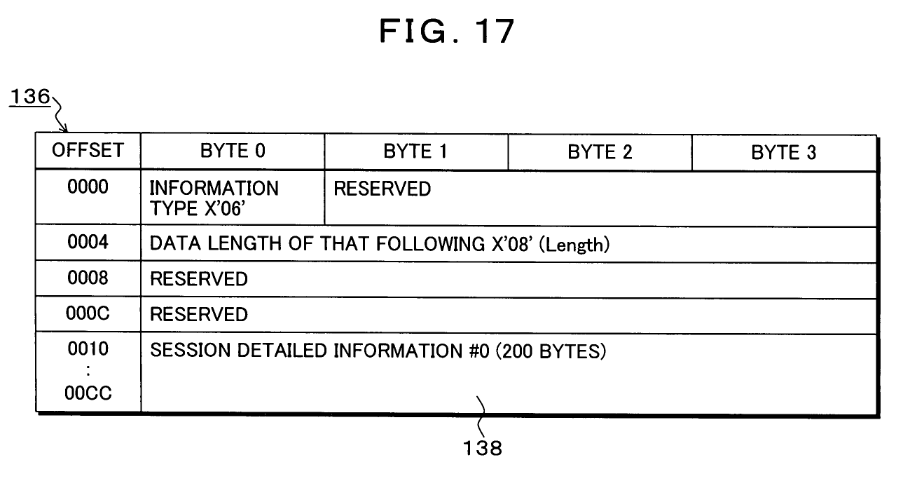

FIG. 17 is an explanatory diagram of session information 136 which is transferred to the copy destination by the stop command 134 of FIG. 16. The session information 136 includes session detailed information 138 of the sessions to be stopped, and the description thereof is same as offset 0010 to 00CC of FIG. 15. As the commands used in remote copy of the RAID devices 14 and 16, a physical information acquisition command, a session ID acquisition command, a session information acquisition command, a termination command, a resume command, etc. are prepared in addition to the start command and the stop command. The physical information acquisition command acquires a chassis identifier and a physical device number. The session ID acquisition command acquires a session ID of a remote copy process. The session information acquisition command acquires session information of remote copy. The termination command terminates remote copy. The resume command resumes terminated remote copy. Furthermore, a remote chassis identifier acquisition command acquires a remote chassis identifier (box ID) which is permitted to communicate with the chassis required for starting remote copy.

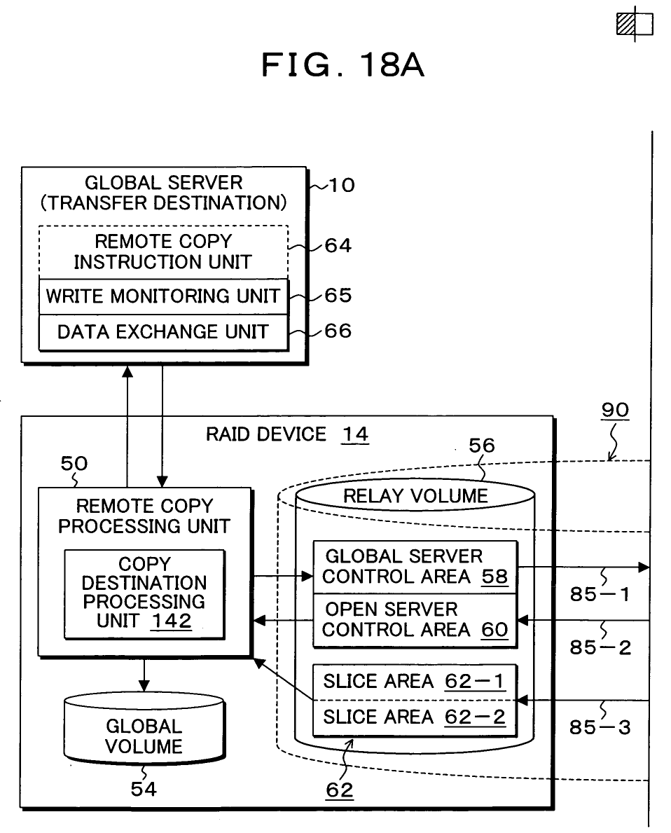

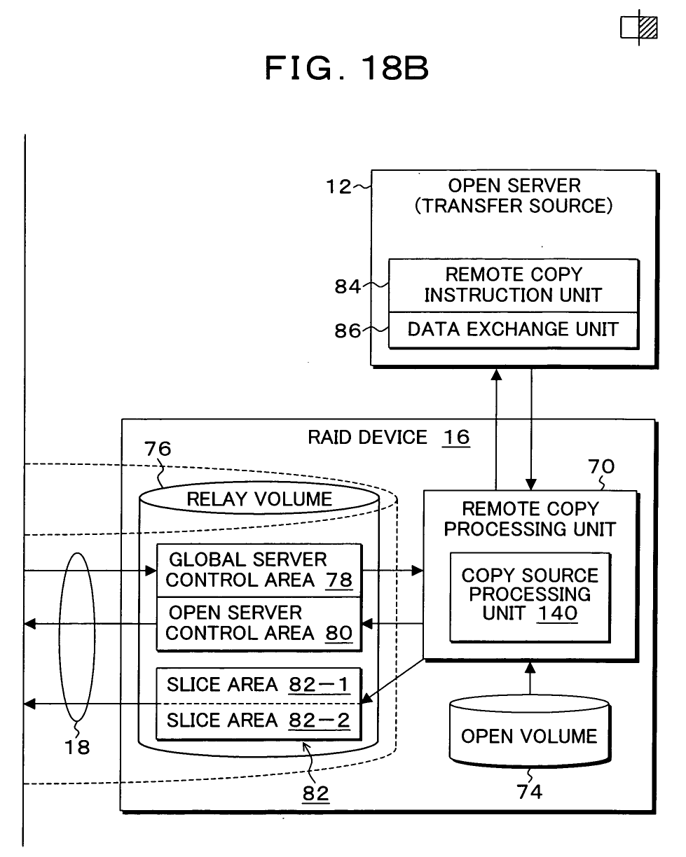

FIGS. 18a and 18B are block diagrams of a functional configuration of an inter-host data process according to the present invention in which an open server serves as a transfer source and a global server serves as a transfer destination; wherein the transfer relation is opposite to that in the case FIGS. 8A and 8B. In FIGS. 18A AND 18B, in the open server 12 serving as the transfer source, when a data transfer request is generated, the remote copy instruction unit 84 issues the start command and the session information to the remote copy processing unit 70 of the RAID device 16, the start command and the session information are further transferred to the remote copy processing unit 50 of the RAID device 14, and sessions 85-1, 85-2, and 85-3 of remote copy in which the copy source is the relay volume 76 and the copy destination is the relay volume 56 are established between the RAID devices 16 and 14. When the sessions 85-1 to 85-3 of remote copy are established, the data exchange unit 86 of the open server 12 writes data transfer instruction information to the open server control area 80 of the relay volume 76, for example, according to an instruction of an application. When this write is performed, according to the equivalency function of remote copy, the data transfer instruction information is written to the open server control area 60 of the relay volume 56 via the inter-chassis path 18. A write monitoring unit 65 of the global server 10 of the transfer destination performs polling on the global server control area 60, thereby recognizing the data transfer instruction information. Subsequently, the data exchange unit 86 of the open server 12 reads out data from the specified file in the open volume 74 and writes it to the relay buffer area 82, and the transfer data is written to the relay buffer area 62 of the relay volume 56 via the inter-chassis path 18 by the equivalence-maintaining function of remote copy. Data write to the relay buffer area 82 is started from the slice area 82-1, and when the slice area 82-1 becomes full, a write completion notification is written to the open server control area 80, thereby switching to write to the slice area 82-2. The data alternately written to the slice areas 82-1 and 82-2 is reflected to the slice areas 62-1 and 62-2 in the relay buffer area 62 of the copy destination through remote copy. When the write monitoring unit 65 of the global server 10 sequentially recognizes the write completion notification, which has been written to the global server control area 58 through remote copy, in the units of the slice areas 82-1 and 82-2, the transfer data in the slice areas 62-1 and 62-2 of the relay buffer area 62 is sequentially read out and written to the global volume 54, and a response about write completion is made when it reaches the transfer data length, as a result, the process in the open server 12 side of the transfer source is completed. When a series of the data transfer is completed, the remote copy stop unit 84 issues the stop command and the session information of the target to be stopped, thereby causing the RAID devices 14 and 16 to release the sessions. According to the bidirectional data transfer function of remote copy between the global server 10 and the open server 12 shown in FIGS. 8A and 8B and FIGS. 18A and 18B, a plurality of sessions based on the function of remote copy can be established simultaneously; therefore, in an actual operation state, the function of FIGS. 8A and 8B and the function of FIGS. 18A and 18B are present at the same time, and data exchange through remote copy of required data is bidirectionally performed according to transfer requests from the servers. Furthermore, the present invention provides a program executed in the global server 10 and the open server 12 for inter-host data transfer, and the program has the substance shown in the flow charts of FIGS. 10A and 10B and FIG. 11. Also, the present invention includes arbitrary modifications that do not impair the object and advantages thereof, and is not limited by the numerical values shown in the above described embodiments.

What is claimed is:

1. An inter-host data transfer method in which RAID devices equipped with a remote copy function are respectively connected to a transfer-source host and a transfer-destination host, and the RAID devices are connected to each other by an inter-chassis path, the inter-host data transfer method characterized by comprising,
in the transfer-source host,
a remote copy instruction step of, upon operation start-up, issuing a start instruction and session information of remote copy to the transfer-source RAID device, and establishing a session of remote copy in which a particular area of a relay volume of the transfer-source RAID device is serving as a copy source and a particular area of a relay volume of the transfer-destination RAID device is serving as a copy destination, and a session of remote copy in which a particular area of the relay volume of the transfer-destination RAID device is serving as a copy source and a particular area of the relay volume of the transfer-source RAID device is serving as a copy destination, and
a transfer-source data exchange step of, when data transfer is instructed, reading out data, which is specified by a data transfer instruction, from a volume for the host of the transfer-source RAID device, and writing the data to a relay buffer area of the relay volume, thereby subjecting the data to remote copy; and comprising,
in the transfer-destination host,
a write monitoring step of monitoring write of transfer data through remote copy with respect to the relay volume of the transfer-destination RAID device, and
a transfer-destination data exchange step of, when transfer data write completion is detected in the write monitoring step, reading out the transfer data in the relay volume and storing the data to a volume for the transfer-destination host.

2. The inter-host data transfer method according to claim 1, characterized in that, in the transfer-source data exchange step, preceding remote copy of the transfer data, data transfer instruction information is written to the relay volume of the transfer-source RAID device, thereby notifying it to the transfer-destination host via the transfer-destination RAID device through remote copy.

3. The inter-host data transfer method according to claim 1, characterized in that, in the transfer-source data exchange step, a code of the transfer data read out from the volume for the transfer-source host is converted into a code system matched to the transfer-destination host and is written to the transfer-source relay volume.

4. The inter-host data transfer method according to claim 1, characterized in that, in the transfer-source data exchange step, the transfer data is written to the relay buffer area disposed in the relay volume of the transfer-source RAID device, thereby subjecting it to remote copy; and,
in the transfer-destination data exchange step, the transfer data written to a relay buffer area disposed in the relay volume of the transfer-destination RAID device through remote copy is read out, and is written to the volume for the transfer-destination host.

5. The inter-host data transfer method according to claim 1, characterized in that, in the remote copy instruction step, when a data transfer completion notification is received from the transfer-destination host, a stop command and session information are issued to the transfer-source RAID device, thereby releasing the sessions of remote copy.

6. The inter-host data transfer method according to claim 1, characterized in that the transfer-source host and the transfer-destination host are a global server and an open server, a global server and a global server, or an open server and an open server.

7. A program characterized by causing a computer of a transfer-source host for accessing a transfer-source RAID device which is connected to, via an inter-chassis path, a transfer-destination RAID device connected to a transfer-destination host to execute
a remote copy instruction step of, upon operation start-up, issuing a start instruction and session information of remote copy to the transfer-source RAID device, and establishing a session of remote copy in which a particular area of a relay volume of the transfer-source RAID device is serving as a copy source and a particular area of a relay volume of the transfer-destination RAID device is serving as a copy destination, and a session of remote copy in which a particular area of the relay volume of the transfer-destination RAID device is serving as a copy source and a particular area of the relay volume of the transfer-source RAID device is serving as a copy destination; and
a transfer-source data exchange step of, when data transfer is instructed, reading out data, which is specified by a data transfer instruction, from a volume for the host of the transfer source, and writing the data to a relay buffer area of the relay volume, thereby subjecting the data to remote copy.

8. The program according to claim 7, characterized in that, in the transfer-source data exchange step, preceding remote copy of the transfer data, data transfer instruction information is written to the relay volume of the transfer-source RAID device, thereby notifying it to the transfer-destination host via the transfer-destination RAID device through remote copy.

9. The program according to claim 7, characterized in that, in the transfer-source data exchange step, a code system of the transfer data read out from the volume for the transfer-source host is converted into a code system which is matched to the transfer-destination host and is written to the transfer-source relay volume.

10. The program according to claim 7, characterized in that, in the transfer-source data exchange step, the transfer data is written to the relay buffer area disposed in the relay volume of the transfer-source RAID device, thereby subjecting the data to remote copy.

11. The program according to claim 7, characterized in that, in the remote copy instruction step, when a data transfer termination instruction is received, a stop command and session information are issued to the transfer-source RAID device, thereby releasing the sessions of remote copy.

12. A program characterized by causing a computer of a transfer-destination host for accessing a transfer-destination RAID device which is connected to, via an inter-chassis path, a transfer-source RAID device connected to a transfer-source host to execute
a write monitoring step of monitoring write of transfer data through remote copy with respect to a particular area of the relay volume of the transfer-destination RAID device, and
a transfer-destination data exchange step of, when transfer data write completion is detected in the write monitoring step, reading out the transfer data in the relay volume and storing the data to a volume for the transfer-destination host.

13. The program according to claim 12, characterized in that, in the transfer-destination data exchange step, the transfer data written to a relay buffer area disposed in the relay volume of the transfer-destination RAID device through remote copy is read out, and is written to the volume for the transfer-destination host.

14. The program according to claim 7 or 12, characterized in that the transfer-source host and the transfer-destination host are a global server and an open server, a global server and a global server, or an open server and an open server.

15. An inter-host data transfer system in which RAID devices equipped with a remote copy function are respectively connected to a transfer-source host and a transfer-destination host, and the RAID devices are connected to each other by an inter-chassis path, the inter-host data transfer system characterized by comprising,
in the transfer-source host,
a remote copy instruction unit for, upon operation start-up, issuing a start instruction and session information of remote copy to the transfer-source RAID device, and establishing a session of remote copy in which a particular area of a relay volume of the transfer-source RAID device is serving as a copy source and a particular area of a relay volume of the transfer-destination RAID device is serving as a copy destination, and a session of remote copy in which a particular area of the relay volume of the transfer-destination RAID device is serving as a copy source and a particular area of the relay volume of the transfer-source RAID device is serving as a copy destination, and
a transfer-source data exchange unit for, when data transfer is instructed, reading out data, which is specified by a data transfer instruction, from a volume for the host of the transfer-source RAID device, and writing the data to a relay buffer area of the relay volume, thereby subjecting the data to remote copy; and comprising,
in the transfer-destination host,
a write monitoring unit for monitoring write of transfer data through remote copy with respect to the relay volume of the transfer-destination RAID device, and
a transfer-destination data exchange unit for, when transfer data write completion is detected by the write monitoring unit, reading out the transfer data in the relay volume and storing the data to a volume for the transfer-destination host.

16. The inter-host data transfer system according to claim 15, characterized in that, preceding remote copy of the transfer data, the transfer-source data exchange unit writes data transfer instruction information to the relay volume of the transfer-source RAID device, thereby notifying it to the transfer-destination host via the transfer-destination RAID device through remote copy.

17. The inter-host data transfer system according to claim 15, characterized in that, the transfer-source data exchange unit converts a code system of the transfer data read out from the volume for the transfer-source host into a code system matched to the transfer-destination host, and writes it to the transfer-source relay volume.

18. The inter-host data transfer system according to claim 15, characterized in that, the transfer-source data exchange unit writes the transfer data to the relay buffer area disposed in the relay volume of the transfer-source RAID device, thereby subjecting it to remote copy; and, the transfer-destination data exchange unit reads out the transfer data written to a relay buffer area disposed in the relay volume of the transfer-destination RAID device through remote copy, and writes it to the volume for the transfer-destination host.

19. The inter-host data transfer system according to claim 15, characterized in that, when a data transfer completion notification is received from the transfer-destination host, the remote copy instruction unit issues a stop command and session information to the transfer-source RAID device, thereby releasing the sessions of remote copy.

20. The inter-host data transfer system according to claim 15, characterized in that the transfer-source host and the transfer-destination host are a global server and an open server, a global server and a global server having different volume data formats, or an open server and an open server having different volume data formats.
